(19) United States
(12) Patent Application Publication
(10) Pub. No.: US 2025/0111779 A1
(43) Pub. Date: Apr. 3, 2025

(54) SYSTEM AND METHOD FOR RECOMMENDING A SAFE PARKING LOCATION FOR PARKING A VEHICLE

(71) Applicant: Toyota Motor Engineering & Manufacturing North America, Inc., Plano, TX (US)

(72) Inventors: Seyhan Ucar, Mountain View, CA (US); Divya Sai Toopran, Sunnyvale, CA (US); Emrah Akin Sisbot, Mountain View, CA (US); Haritha Muralidharan, Cupertino, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/478,013

(22) Filed: Sep. 29, 2023

(51) Int. Cl. G08G 1/14; B60W 30/06; B60W 50/14; B60W 60/00

(52) U.S. Cl. CPC G08G 1/143; B60W 30/06; B60W 50/14; B60W 60/0016; G08G 1/145; B60W 2050/146; B60W 2556/50; B60W 2756/10

(57) ABSTRACT

Systems and methods for recommending a safe parking location are disclosed herein. In one example, a system includes a processor and a memory having instructions that, when executed by the processor, cause the processor to determine a safe parking location for a vehicle from a plurality of parking locations based on reason information and transmit a location of the safe parking location to the vehicle. The reason information is based on vehicle network activity occurring in vehicles parked at the plurality of parking locations.

### TECHNICAL FIELD

The subject matter described herein relates, in general, to systems and methods for recommending a safe parking location for parking vehicles.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

In the past, parking a vehicle usually required that the vehicle driver have detailed knowledge regarding the location of parking facilities and/or utilize signage to direct them to appropriate parking facilities. However, the safety of such parking facilities was generally not known to the driver. More recently, location-based crime statistics have been utilized to determine the overall safety of parking facilities. However, these location-based crime statistics are collected from publicly available databases and do not necessarily indicate the overall safety of a parking facility. For example, a parking facility with active security personnel in a high-crime area may be safer than one in a lower-crime area that does not have active security personnel.

### SUMMARY

This section generally summarizes the disclosure and is not a comprehensive explanation of its full scope or all its features.

In one embodiment, a system includes a processor and a memory having instructions that, when executed by the processor, cause the processor to determine a safe parking location for a vehicle from a plurality of parking locations based on reason information and transmit a location of the safe parking location to the vehicle. The reason information is based on vehicle network activity occurring in vehicles parked at the plurality of parking locations.

In another embodiment, a method includes steps of determining a safe parking location for a vehicle from a plurality of parking locations based on reason information and transmitting a location of the safe parking location to the vehicle. Like before, the reason information is based on vehicle network activity occurring in vehicles parked at the plurality of parking locations.

In yet another embodiment, a non-transitory computer-readable medium includes instructions that, when executed by a processor, causes the processor to determine a safe parking location for a vehicle from a plurality of parking locations based on reason information and transmit a location of the safe parking location to the vehicle. Again, the reason information is based on vehicle network activity occurring in vehicles parked at the plurality of parking locations.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example scenario of a vehicle being provided with a safe parking location recommendation by a system.

FIG. 2 illustrates vehicles providing reason information to a system when located in a parking lot.

FIG. 3 illustrates a more detailed view of a vehicle and a system that can provide vehicles with a safe parking location recommendation.

FIG. 4 illustrates a method for determining a safe parking location.

### DETAILED DESCRIPTION

Described are systems and methods for recommending a safe parking location. In one example, a system for recommending a safe parking location receives reason information from vehicles parked at a particular parking location. The reason information may be generated by the vehicle based on vehicle network activity occurring on a vehicle network, such as a controller area network (CAN). Moreover, network traffic on the CAN bus can be utilized to reason if the parking location is safe. For example, network activity on the CAN bus indicating that the vehicle has experienced a break-in, a stolen catalytic converter and/or wheels/tires, and/or if the parking location is relatively difficult to access and requires multiple maneuvers can be utilized to determine the reason information. This reason information can then be collected by a server that can amalgamate this information to recommend to other vehicles where they should park. The reason information could be from a single vehicle of from vehicles in nearby vicinity. Vehicles may communicate over vehicle-to-vehicle communication (e.g., Wi-Fi) and reason about the situation.

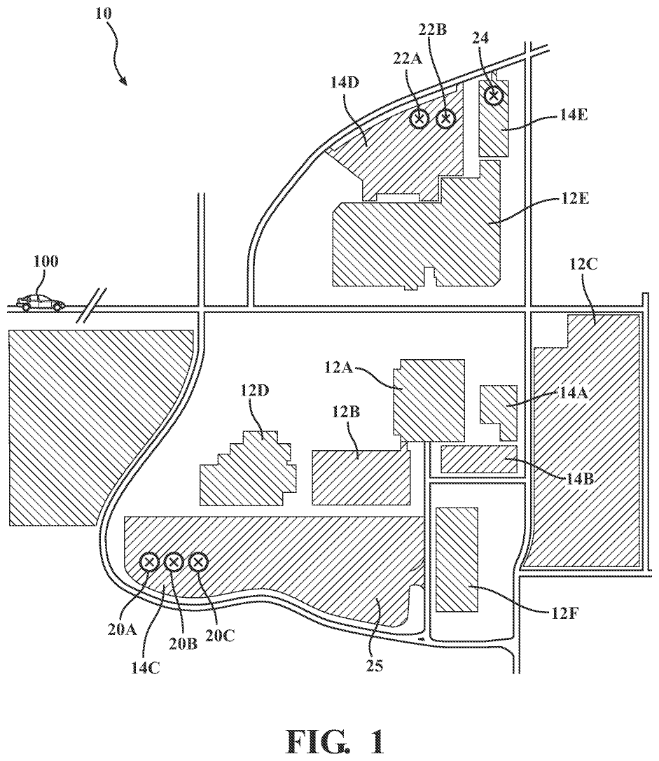

Referring to FIG. 1, illustrated is a map 10 that includes several buildings 12A-12F and parking locations 14A-14E. In this example, the buildings 12A-12F may represent different potential destinations that an occupant of a vehicle 100 may want to travel to. Here, the occupant of the vehicle 100 intends to travel to building 12A. The parking locations 14A-14E are all within walking distance to the building 12A, and therefore, any of them can be utilized by the occupant of the vehicle 100. However, unless the occupant of the vehicle 100, through previous experience and/or experiences of others, knows which parking location of the plurality of parking locations 14A-14E is considered safe, the occupant is most likely to park the vehicle 100 at whichever parking location is most convenient for them to find.

Before going further, it should be understood that the parking locations 14A-14E can be any type of parking location for which the vehicle 100 can be parked. As such, the parking locations 14A-14E may be surface lots, multilevel parking facilities, street parking, underground parking facilities, or even individual parking spots. Further still, the parking locations 14A-14E may be a portion or subset of a larger parking location. For example, the parking locations could represent one or more levels of a multilevel parking structure, wherein different levels have different parking locations. In another example, the same surface parking lot could be subdivided into different parking locations.

In this example, reason information from vehicles that have utilized one or more of the parking locations 14A-14E have been provided to a remote server, and the remote server has amalgamated this information to determine which of the parking locations 14A-14E may have some type of negative event that may have occurred, such as vehicle break-in/theft, catalytic converter theft, tire/wheel theft, or may simply be difficult to park, such as requiring numerous maneuvers by the driver the vehicle. In this example, parking locations 14C, 14D, and 14E have had negative events occur, as indicated by indicators 20A-20C, 22A-22B, and 24, respectively. As such, assuming that the destination of the vehicle 100 is building 12E, the server may recommend parking in a safer parking location, such as parking locations 14A and 14B. It is also possible the server may recommend parking in a certain section of a parking location. For example, the server may recommend parking in the northeast quadrant 25, further away from indicators 20A-20C.

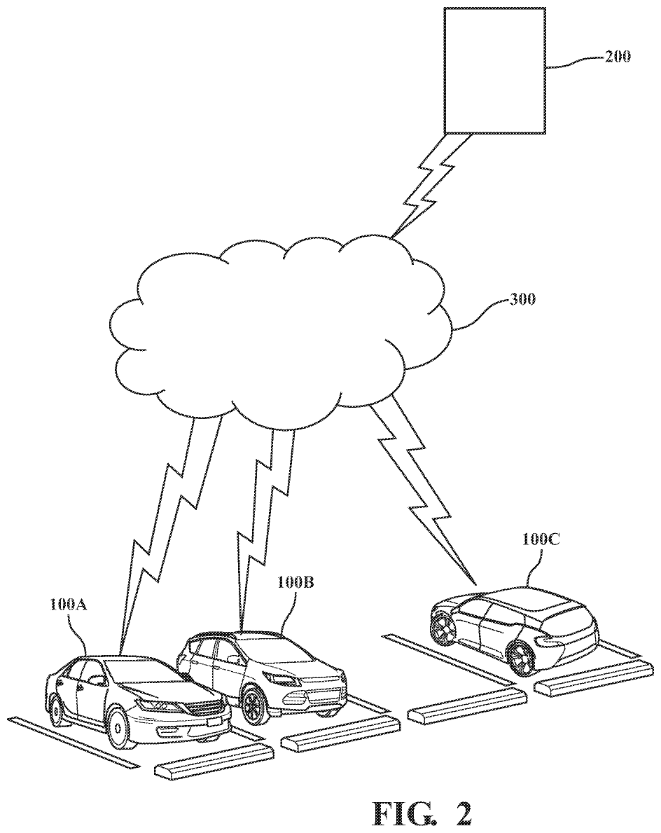

FIG. 2 illustrates one example of vehicles that provide reason information to a server, such as a system 200 for recommending parking locations. Here, the system 200 may be a remote server and can communicate with one or more vehicles 100A-100C via a network 300, which may be a distributed network. Any of a number of different networking technologies can allow the system 200 to communicate with the vehicles 100A-100C, such as Wi-Fi, cellular, Dedicated Short-Range Communications (DSRC), and the like. Additionally, it should be understood that the vehicles 100A-100C may be able to form a vehicle ad hoc network and/or vehicular micro cloud, so the information generated from one vehicle may be communicated to the system 200 via another vehicle. U.S. Pat. No. 10,587,998 describes the formation of vehicular micro cloud and is hereby incorporated by reference in its entirety.

The vehicles 100A-100C may directly provide the reason information to the system 200 or may provide network activity information to the system 200 so that the system 200 can generate the reason information. In some cases, the vehicles 100A-100C may also share resources among themselves, wherein one vehicle may have additional computational resources for generating and/or sending the reason information based on network activity information received from other vehicles.

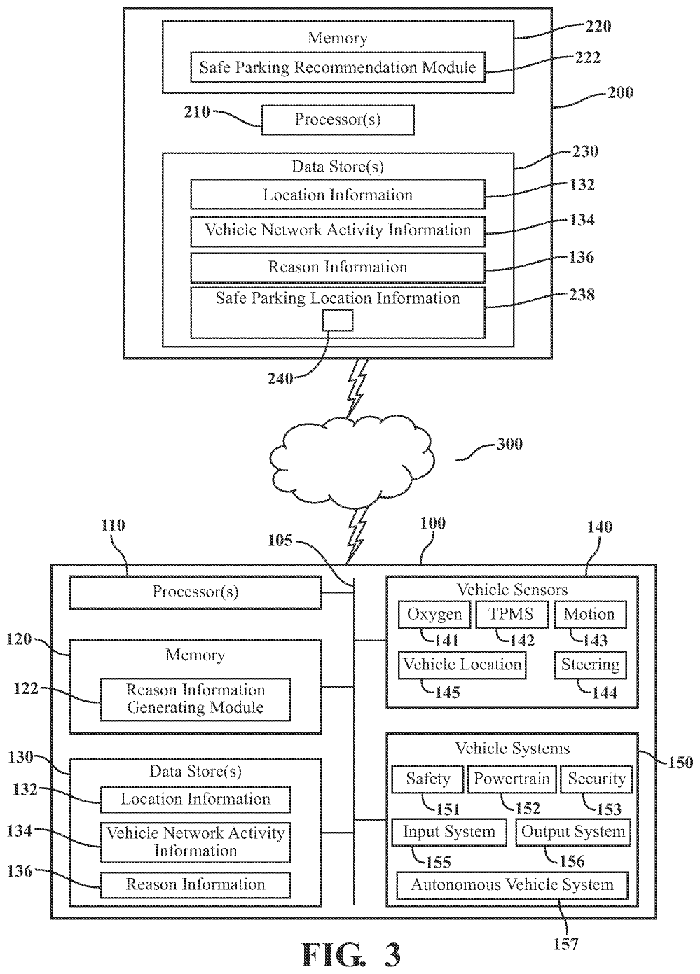

Referring to FIG. 3, illustrated are more detailed views of the system 200 and a vehicle 100, wherein reason information is utilized to recommend a safe parking location for the vehicle 100 (or another vehicle) by the system 200. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein.

In various embodiments, the automated/autonomous systems or combination of systems of the vehicle 100 may vary. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control. Additionally, it should be understood that the vehicle 100 may be non-autonomous.

The vehicle 100 also includes various elements. It will be understood that in various embodiments it may not be necessary for the vehicle 100 to have all of the elements shown in FIG. 3. The vehicle 100 can have any combination of the various elements shown in FIG. 3. Further, the vehicle 100 can have additional elements to those shown in FIG. 3. In some arrangements, the vehicle 100 may be implemented without one or more of the elements shown in FIG. 3. While the various elements are shown as being located within the vehicle 100 in FIG. 3, it will be understood that one or more of these elements can be located external to the vehicle 100. Further, the elements shown may be physically separated by large distances and provided as remote services (e.g., cloud-computing services).

In one example, the vehicle 100 includes a data bus 105 that may be part of a vehicle network. In one example, the vehicle network may be a CAN-type network. However, it should be understood that any type of network may be utilized within the vehicle 100. Generally, systems and subsystems of the vehicle 100 communicate with each other by sending messages on the data bus 105. As such, information generated by sensors, such as tire pressure monitoring system (TPMS) sensors, oxygen sensors, inertial sensors, and the like, may be transmitted on the data bus 105. Similarly, information generated by vehicle systems, such as a powertrain system, safety system, and the like, may also be transmitted on the data bus 105.

In this example, the vehicle 100 includes vehicle sensors 140, such as oxygen sensors 141, TPMS sensors 142, motion sensors 143, steering sensor 144, and vehicle location sensors 145. Generally, oxygen sensors 141 are utilized to check the amount of oxygen in the exhaust, which may be utilized to determine the right air-to-fuel ratio for best engine performance. In cases where the exhaust system of the vehicle has been tampered with, such as theft of the catalytic converter, the oxygen sensors 141 generate information that an electronic control unit, such as the processor(s) 110, may determine that the exhaust is either malfunctioning or has been tampered with. Information generated by the oxygen sensors 141 and/or the electronic control unit may be provided to the data bus 105.

TPMS sensors 142 generate information regarding the tire pressure of one or more vehicle tires. TPMS sensors 142 are generally mounted on the vehicle's wheel and measure the tire pressure of one or more tires of the vehicle 100. When a wheel of the vehicle 100 is removed, the TPMS sensor 142 associated with that particular wheel may not be able to transmit any information to the data bus 105. When this occurs, one or more electronic control units of the vehicle 100 may determine a fault, indicating that the TPMS sensor 142 is not sending any information and transmit this information to the data bus 105. As such, if one or more wheels of the vehicle 100 are stolen, sensor information from the TPMS sensor 142 associated with the stolen wheel will not be provided to the data bus 105, and an error may be generated by one or more electronic control units of the vehicle 100.

The motion sensors 143 of the vehicle 100 can include any type of motion sensor, such as accelerometers, inertial measurement units, gyroscopes, etc. Generally, these motion sensors 143 can provide information regarding the movement of the vehicle 100. As such, if the vehicle 100 is moving backward and forwards to park, information is generated by the motion sensors 143 and provided to the data bus 105.

The steering sensor 144 can provide information regarding the steering of the vehicle, such as changes in the steering angle of the vehicle 100. As such, if the steering of the vehicle 100 is changed to pilot the vehicle to a particular location or to park the vehicle, this information is generated by the steering sensor 144 and provided to the data bus 105.

The vehicle location sensor 145 may be a sensor or may be a system that can determine the location of the vehicle 100. In some cases, the vehicle location sensor 145 may be a global navigation satellite system (GNSS) that utilizes satellites to provide autonomous geo-positioning. Examples of GNSS that may be utilized by the vehicle 100 include Global Positioning System (GPS), Global Navigation Satellite System (GLONASS), BeiDou Navigation Satellite System, and Galileo.

The vehicle systems 150 can vary considerably. However, in this example, the vehicle systems include a safety system 151, a security system 152, a powertrain system 153, an input system 155, an output system 156, and an autonomous vehicle system 157. As stated before, these systems can vary considerably from vehicle to vehicle. For example, the vehicle 100 may be non-autonomous and not include the autonomous vehicle system 157.

The safety system 151 may be related to one or more safety systems of the vehicle 100. The safety systems can include both passive and active safety systems and can act to interpret data from the vehicle sensors 140 to determine when they should be deployed. For example, the safety system 151 may receive information from the vehicle sensors 140 to determine when an airbag should be deployed, pre-tensioners tightened, brake/steering/throttle actuation, etc.

The security system 152 may be a security system for the vehicle 100 that interprets information from the vehicle sensors 140 to determine if one or more safety mitigation systems should be actuated. For example, suppose the vehicle is accessed without being unlocked, such as a smashed window or forced entry. In that case, the security system may actuate the horns and/or lights of the vehicle 100 by communicating using the data bus 105.

The powertrain system 153 relates to any of the powertrain components of the vehicle 100. Powertrains can vary from vehicle to vehicle. For example, some vehicles are traditional internal combustion engine vehicles, while others are electric. Further still, some vehicles are a combination of both and may be hybrid electric vehicles or plug-in hybrid electric vehicles. As such, the powertrain systems of these vehicles vary considerably. In either case, the powertrain system 153 may communicate information generated by one or more powertrain components, such as the gear position (drive, park, reverse, etc.), throttle position, and the like.

The vehicle 100 can include an input system 155. An “input system” includes any device, component, system, element, arrangement, or group that enables information/data to be entered into a machine. The input system 155 can receive an input from a vehicle passenger (e.g., a driver or a passenger). The vehicle 100 can include an output system 156. An “output system” includes any device, component, arrangement, or group that enables information/data to be presented to a vehicle passenger (e.g., a person, a vehicle passenger, etc.). For example, recommendations for a safe parking location may be displayed to the occupant of the vehicle 100 via the output system 156.

As mentioned before, the vehicle 100 may include an autonomous vehicle system 157, which functions to pilot the vehicle 100 autonomously or semi-autonomously. The autonomous vehicle system 157 can be configured to receive data from the vehicle sensors 140 and/or any other type of system capable of capturing information relating to the vehicle 100 and/or the external environment of the vehicle 100. The autonomous vehicle system 157 can be configured to determine travel path(s), current autonomous driving maneuvers for the vehicle 100, future autonomous driving maneuvers and/or modifications to current autonomous driving maneuvers based on data acquired by the vehicle sensors 140, driving scene models, and/or data from any other suitable source. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The autonomous vehicle system 157 can be configured to implement determined driving maneuvers.

The autonomous vehicle system 157 can cause, directly or indirectly, such autonomous driving maneuvers to be implemented. As used herein, “cause” or “causing” means to make, command, instruct, and/or enable an event or action to occur or at least be in a state where such event or action may occur, either directly or indirectly. The autonomous vehicle system 157 can be configured to execute various vehicle functions and/or transmit data to, receive data from, interact with, and/or control the vehicle 100 or one or more systems (e.g., one or more of vehicle systems 150).

The vehicle can include one or more electronic control units with one or more processor(s) 110. In one or more embodiments, the processor(s) 110 is an application-specific integrated circuit that is configured to implement functions associated with a reason information generating module 122. In general, the processor(s) 110 is an electronic processor, such as a microprocessor, capable of performing various functions described herein. In one embodiment, the vehicle 100 includes a memory 120 that stores the reason information generating module 122. The memory 120 may be a random-access memory (RAM), read-only memory (ROM), a hard disk drive, a flash memory, or other suitable memory for storing the reason information generating module 122. The reason information generating module 122 is, for example, computer-readable instructions that, when executed by the processor(s) 110, cause the processor(s) 110 to perform the various functions disclosed herein.

Furthermore, in one embodiment, the vehicle may include one or more data stores 130. The data stores 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store 130 stores data used by the reason information generating module 122 in executing various functions. In one embodiment, the data store 130 includes location information 132, vehicle network activity information 134, and/or reason information 136.

Generally, the location information 132 may be the present and/or past locations of the vehicle 100. The vehicle network activity information 134 may be network activity generated by the vehicle sensors 140 and/or the vehicle systems 150 and provided to the data bus 105. Finally, the reason information 136 may be information based on the vehicle network activity information 134. As will be explained later, the reason information 136 is utilized by the system 200 to determine a safe parking location for the vehicle 100 (or other vehicles) to park.

The reason information generating module 122 generally includes instructions that cause the processor(s) 110 to generate the reason information 136 based on the vehicle network activity information 134. In some cases, the vehicle network activity information 134 includes:
vehicle horn data, vehicle lock data, or vehicle lamp data,
oxygen sensor data,
vehicle maneuvering data, and
tire pressure monitoring data.

Of course, it should be understood that the vehicle network activity information 134 given above is just an example of what information could be included within the vehicle network activity information. Any type of information generated by the vehicle sensors 140 and/or the vehicle systems 150 could form part of the vehicle network activity information 134.

The instructions of the reason information generating module 122 cause the processor(s) 110 to evaluate the vehicle network activity information 134 to determine one or more reasons if there are any issues while the vehicle 100 was parked at a particular parking location. For example, if the vehicle network activity information 134 indicates the presence of vehicle horn data, vehicle lock data, and/or vehicle lamp data, the processor(s) 110 may determine that the vehicle 100 was broken into one parked at a particular parking location and save this determination within the reason information 136.

In another example, if the vehicle network activity information 134 indicates the presence of oxygen sensor data, the processor(s) 110 may determine that the vehicle 100 had its catalytic converter stolen/tampered with and save this determination within the reason information 136. Further still, if the vehicle network activity information 134 indicates the presence of tire pressure monitoring data, the processor(s) 110 may determine that the vehicle 100 had its wheels/tires stolen or tampered with and save this determination within the reason information 136.

The reason information 136 can also include how difficult it is to park a vehicle at a particular parking location. For example, if the vehicle network activity information 134 indicates vehicle maneuvering data, the processor(s) 110 may determine that it was difficult to park the vehicle 100 at that particular parking location.

The reason information 136 may be generated onboard the vehicle 100 by the processor(s) 110. However, it should be understood that the reason information 136 may be generated elsewhere. For example, the vehicle network activity information 134 could be transmitted or shared with another vehicle that can assist with generating the reason information 136. As such, the vehicle network activity information 134 could be generated by one vehicle and processed by another vehicle. Further still, the vehicle network activity information 134 could be provided to the system 200, which could then generate the reason information 136.

Generally, the processor(s) 110 then transmits to the system 200 via the network 300 the reason information 136 and the location information 132. Essentially, the reason information 136 identifies issues that a vehicle encountered when parking, and the location information 132 identifies the location where the vehicle was parked.

Turning attention to the system 200, the system 200 includes a processor(s) 210, which may be an application-specific integrated circuit configured to implement functions associated with a safe parking recommendation module 222. In general, the processor(s) 210 is an electronic processor, such as a microprocessor, capable of performing various functions described herein. In one embodiment, the system 200 includes a memory 220 that stores the safe parking recommendation module 222. The memory 220 may be a random-access memory (RAM), read-only memory (ROM), a hard disk drive, a flash memory, or other suitable memory for storing the safe parking recommendation module 222. The safe parking recommendation module 222 is, for example, computer-readable instructions that, when executed by the processor(s) 210, cause the processor(s) 210 to perform the various functions disclosed herein.

Furthermore, in one embodiment, the system 200 may include one or more data stores 230. The data stores 230 is, in one embodiment, an electronic data structure such as a database that is stored in the memory 220 or another memory and that is configured with routines that can be executed by the processor(s) 210 for analyzing stored data, providing stored data, organizing stored data, and so on. Thus, in one embodiment, the data store 230 stores data used by the safe parking recommendation module 222 in executing various functions. In one embodiment, the data store 230 includes location information 132, vehicle network activity information 134, reason information 136, and/or safe parking location information.

As mentioned before, when the vehicle 100 or another external device (not including the system 200) determines the reason information 136 based on the vehicle network activity information 134, the system 200 may only receive and/or store the location information 132, and the reason information 136. In situations where the system 200 receives the vehicle network activity information 134, the system 200 may generate the reason information 136 instead of the vehicle. The system 200 may generate the reason information 136, similar to what was previously described when describing the vehicle 100.

Regardless of where the reason information 136 was generated, the safe parking recommendation module 222 causes the processor(s) 210 to generate the safe parking location information 238 utilizing the location information 132 and the reason information 136. Moreover, the safe parking recommendation module 222 causes the processor(s) 210 to associate issues described in the reason information 136 with various parking locations/facilities that may be stored in a database 240. The database 240 may contain lists of parking locations. The processor(s) 210 identifies the parking locations using the location information 132 and then associates the reason information 136 with a particular parking location. As such, the database 240 of parking locations includes electronic information regarding where the location is and any issues that vehicles have experienced at that location by using the reason information 136.

For example, returning to FIG. 1, parking locations 14C, 14D, and 14E all had issues associated with them, as indicated by indicators 20A-20C, 22A-22B, and 24, respectively. These indicators 20A-20C, 22A-22B, and 24 may indicate various issues as described in the reason information 136. For example, indicators 20A-20C, 22A-22B, and 24 may relate to vehicle theft, catalytic converter theft/temper, wheel/tire theft, or that parking at that particular location is difficult.

The safe parking recommendation module 222 causes the processor(s) 210 to determine a recommendation for parking the vehicle 100 using the safe parking location information 238. For example, the processor(s) 210 may also receive destination information from the occupant of the vehicle 100. Generally, all things being equal, the processor(s) 210 may recommend the closest parking location. However, the safe parking recommendation module 222 also causes the processor(s) 210 to consider the various issues described in the reason information 136 when recommending where to park. For example, if a particular parking location has numerous issues determined from the reason information 136, while slightly further parking location has fewer issues, the processor(s) 210 may recommend the further parking location instead of the closer but more unsafe parking location.

The safe parking recommendation module 222 can also cause the processor(s) 210 to consider the type of vehicle that is being parked when making a recommendation. For example, if the issues of a particular parking location relate mostly to catalytic converter theft and the vehicle in question is an electric vehicle, the processor(s) 210 may discount or ignore issues related to catalytic converter theft, as they would not be a concern to a person having an electric vehicle.

Additionally, the number of issues in comparison of the size of the parking location can also play a role. For example, if a fairly large parking lot and a fairly small parking lot have the same number of issues, the fairly large parking lot would be more likely to be recommended, as the size the parking lot in comparison to the number of issues indicates a lower likelihood of a vehicle experiencing an unfortunate event. Further still, portions of a parking location may be recommended while other portions may be discouraged. For example, if portions of a parking location closest to an entrance/exit are safer than portions located further away, only those portions may be recommended. Other factors can also be utilized to determine which parking location to recommend. For example, parking locations that provide an easier entrance/exit may be deemed fewer issues than parking locations that are harder to enter/exit.

Upon determining the safe parking location, the safe parking recommendation module 222 causes the processor(s) 210 to transmit the recommendation to the vehicle 100 (or any other vehicle requesting a parking recommendation) via the network 300. From there, the vehicle 100 may be caused to display the recommendation to the occupant of the vehicle 100 via the output system 156 or, in cases where the vehicle 100 is autonomous, provide the parking recommendation to the autonomous vehicle system 157, causing the vehicle 100 to maneuver towards the recommended parking location.

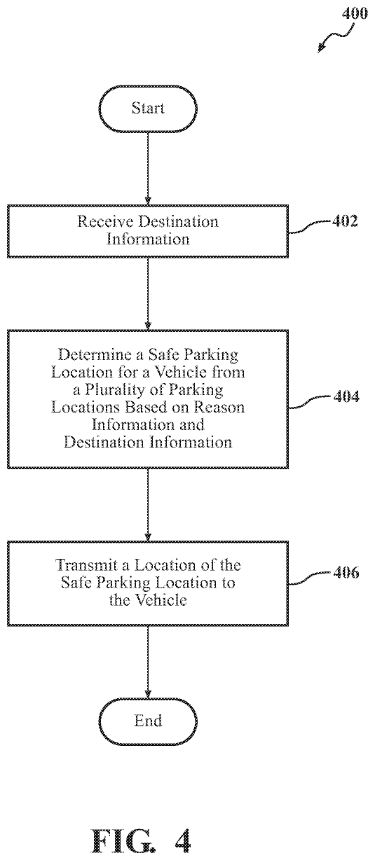

Referring to FIG. 4, a method 400 for recommending a safe parking location is shown. The method 400 will be described from the viewpoint of the system 200 of FIG. 3. However, it should be understood that this is just one example of implementing the method 400. While method 400 is discussed in combination with the system 200, it should be appreciated that the method 400 is not limited to being implemented within the system 200. Instead, it is one example of a system that may implement the method 400.

In step 402, the system 200 may receive destination information from a vehicle, such as the vehicle 100. The destination information may be information detailing the location of the destination to which the vehicle 100 is traveling.

In step 404, the safe parking recommendation module 222 causes the processor(s) 210 to determine a safe parking location for the vehicle from a plurality of parking locations based on reason information 136 and the destination information of the vehicle 100. As explained previously, the safe parking recommendation module 222 causes the processor(s) 210 to associate issues described in the reason information 136 with various parking locations/facilities that may be stored in a database 240. The database 240 may contain lists of parking locations. The processor(s) 210 identifies the parking locations using the location information 132 and then associates the reason information 136 with a particular parking location. As such, the database of parking locations includes electronic information regarding where the location is and any issues that vehicles have experienced at that location by using the reason information 136.

Using the destination location of the vehicle 100, the safe parking recommendation module 222 causes the processor(s) 210 to determine parking locations near the destination and filter out parking locations that may have issues based on the reason information 136. For example, if a particular parking location has numerous issues determined from the reason information 136, while slightly further parking location has fewer issues, the processor(s) 210 may recommend the further parking location instead of the closer but more unsafe parking location.

Once a safe parking location has been determined, the safe parking recommendation module 222 causes the processor(s) 210 to transmit the safe parking location to the vehicle 100, as shown in step 406. From there, this may cause the vehicle 100 to display this information to the occupant of the vehicle 100 and/or cause an autonomous vehicle system 157 of the vehicle 100 to maneuver the vehicle 100 towards the recommended safe parking location.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code comprising one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

As such, the systems and methods described herein can recommend safe parking locations based on network activity of vehicles that have actually parked in those parking locations. By so doing, safe parking locations can be more accurately identified than using publicly available databases that may be out of date, biased, or otherwise incorrect.

The systems, components and/or processes described above can be realized in hardware or a combination of hardware and software and can be realized in a centralized fashion in one processing system or in a distributed fashion where different elements are spread across several interconnected processing systems. Any processing system or apparatus adapted for the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements can also be embedded in an application product that comprises all the features enabling the implementation of the methods described herein and which, when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. For example, “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor, the memory having a safe parking recommendation module having instructions that, when executed by the processor, cause the processor to:
determine a safe parking location for a vehicle from a plurality of parking locations based on reason information, the reason information being based on vehicle network activity occurring in vehicles parked at the plurality of parking locations, and
transmit a location of the safe parking location to the vehicle.

2. The system of claim 1, wherein the reason information is determined by vehicles parked at the plurality of parking locations and then transmitted to a remote server.

3. The system of claim 1, wherein the reason information is determined by a remote server upon receiving vehicle network activity from vehicles parked at the plurality of parking locations.

4. The system of claim 1, wherein the vehicle network activity includes one or more of:
vehicle horn data, vehicle lock data, or vehicle lamp data indicating vehicle alarm system activation of vehicles parked at the plurality of parking locations;
oxygen sensor data indicating tampering of catalytic converters of vehicles parked at the plurality of parking locations;
vehicle maneuvering data indicating difficulty in parking vehicles parked at the plurality of parking locations; and
tire pressure monitoring data indicating removal of one or more wheels of vehicles parked at the plurality of parking locations.

5. The system of claim 1, wherein the safe parking recommendation module further includes instructions that, when executed by the processor, cause the processor to determine the safe parking location based further upon one or more of: a location of the vehicle and a destination of the vehicle.

6. The system of claim 1, wherein the safe parking recommendation module further includes instructions that, when executed by the processor, cause the vehicle to autonomously maneuver to the safe parking location.

7. The system of claim 1, wherein the safe parking recommendation module further includes instructions that, when executed by the processor, cause the vehicle to display, via a display device located within the vehicle, the location of the safe parking location.

8. A method comprising steps of:
determining a safe parking location for a vehicle from a plurality of parking locations based on reason information, the reason information being based on vehicle network activity occurring in vehicles parked at the plurality of parking locations; and
transmitting a location of the safe parking location to the vehicle.

9. The method of claim 8, wherein the reason information is determined by vehicles parked at the plurality of parking locations and then transmitted to a remote server.

10. The method of claim 8, wherein the reason information is determined by a remote server upon receiving vehicle network activity from vehicles parked at the plurality of parking locations.

11. The method of claim 8, wherein the vehicle network activity includes one or more of:
vehicle horn data, vehicle lock data, or vehicle lamp data indicating vehicle alarm system activation of vehicles parked at the plurality of parking locations;
oxygen sensor data indicating tampering of catalytic converters of vehicles parked at the plurality of parking locations;
vehicle maneuvering data indicating difficulty in parking vehicles parked at the plurality of parking locations; and
tire pressure monitoring data indicating removal of one or more wheels of vehicles parked at the plurality of parking locations.

12. The method of claim 8, further comprising the step of determining the safe parking location based further upon one or more of: a location of the vehicle and a destination of the vehicle.

13. The method of claim 8, further comprising the step of causing the vehicle to autonomously maneuver to the safe parking location.

14. The method of claim 8, further comprising the step of causing the vehicle to display, via a display device located within the vehicle, the location of the safe parking location.

15. A non-transitory computer-readable medium storing instructions that, when executed by a processor, causes the processor to:
determine a safe parking location for a vehicle from a plurality of parking locations based on reason information, the reason information being based on vehicle network activity occurring in vehicles parked at the plurality of parking locations; and
transmit a location of the safe parking location to the vehicle.

16. The non-transitory computer-readable medium of claim 15, wherein the reason information is determined by vehicles parked at the plurality of parking locations and then transmitted to a remote server.

17. The non-transitory computer-readable medium of claim 15, wherein the reason information is determined by a remote server upon receiving vehicle network activity from vehicles parked at the plurality of parking locations.

18. The non-transitory computer-readable medium of claim 15, wherein the vehicle network activity includes one or more of:
vehicle horn data, vehicle lock data, or vehicle lamp data indicating vehicle alarm system activation of vehicles parked at the plurality of parking locations;
oxygen sensor data indicating tampering of catalytic converters of vehicles parked at the plurality of parking locations;
vehicle maneuvering data indicating difficulty in parking vehicles parked at the plurality of parking locations; and
tire pressure monitoring data indicating removal of one or more wheels of vehicles parked at the plurality of parking locations.

19. The non-transitory computer-readable medium of claim 15, further including instructions that, when executed by a processor, cause the processor to determine the safe parking location based further upon one or more of: a location of the vehicle and a destination of the vehicle.

20. The non-transitory computer-readable medium of claim 15, further including instructions that, when executed by a processor, cause the processor to cause one or more of:
the vehicle to autonomously maneuver to the safe parking location; and
the vehicle to display, via a display device located within the vehicle, the location of the safe parking location.
